(19) United States
(12) Patent Application Publication
(10) Pub. No.: US 2003/0093498 A1
(43) Pub. Date: May 15, 2003

(54) System for identifying and extracting text information using web based imaging

(76) Inventors: Shell S. Simpson, Boise, ID (US); Ward S. Foster, Boise, ID (US); Kris R. Livingston, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/993,116

(22) Filed: Nov. 14, 2001

(51) Int. Cl. G06F 15/16

(52) U.S. Cl. 709/218

(57) ABSTRACT

A system for identifying and extracting text in a distributed processing environment is disclosed. The invention comprises a client computer coupled to a network and including a browser, a server computer coupled to the network, and information associated with a user of the client computer, where a destination service presented by the server computer to the user obtains portions of text in the information. The destination service may access the text by using a code portion that is sent to the user's computer and that is used to identify information relating to the user. Alternatively, the destination service may use a server to directly access the information specific to the user. Once the text information associated with the user is identified, the destination service may employ optical character recognition (OCR) to obtain the text information, or may request a text rendition of the internal representation of an indicated region of a graphic that includes the desired text.

### BACKGROUND OF THE INVENTION

1. Field of the Invention

The invention relates generally to processing data in a distributed environment, and, more particularly, to a system for automatically identifying and extracting text information in a web based imaging computing environment.

2. Related Art

The future of information processing and information sharing over a network promises to open vast and unexpected processing ability. For example, processing systems currently under development promise to allow new and heretofore unprecedented sharing of information over a wide area network (WAN) or a local area network (LAN). Such sharing of information includes the ability to exchange generic information for the ultimate purpose of using the generic information to develop and access a set of user specific information. Such information sharing and generation may include, for example, the ability to customize a user's experience when browsing the World Wide Web (WWW), or “web” portion of the Internet. The term “browsing” refers to directing a user's computer to a particular location on the web and displaying a page associated with that location. These locations are identified by a universal resource locator (URL), which acts as an address for such location. Each web page or device connected to the web can be located and accessed by its unique URL. Such a system of using generic access instructions is disclosed in commonly assigned, co-pending U.S. patent application Ser. No. 09/712,336, titled “SYSTEM AND METHOD FOR PROCESSING DATA IN A DISTRIBUTED ENVIRONMENT,” filed on Nov. 13, 2000, Attorney Docket No. 10003352-1, and hereby incorporated into this document by reference.

One of the benefits of such a distributed processing environment is the ability to allow a user of a computer to have a customized web browsing experience, regardless of the URL that is visited. Such a system uses the above mentioned generic access instructions to access user specific data that is either located on the user's computer or located remotely from the user's computer. Such user specific data may include, for example, imaging information that is specific to the user. In this manner, the user's browsing experience can be consistent regardless of the web site visited and the user can use such user specific imaging information to create, obtain and manipulate images over a network. Included in this user's experience is a user's “home service.” The user's home service, also referred to herein as a user's “web based imaging home service,” can be any URL that the user chooses.

Furthermore, such a distributed processing environment includes not only web sites having web pages to view, but also includes many interconnected devices, such as computers, printers, facsimile machines, etc. When such devices are interconnected in a common network, it would be desirable for a user that browses to their home service to have access to any of the interconnected devices. For example, the user may use their browser to access a printer that is represented by a web service and located remotely from the user. The user may then receive content from the web service that allows the user's browser to present to the user their own user specific data in the context of the web service (the printer to which the user has browsed). Other web services to which the user may browse may include web sites at which the user is required to enter information. For example, when buying postage over the Internet, the user typically must enter the source and destination address of the “letter” for which the user is purchasing the postage. The entering of this information may become tedious if the user is buying postage for more than a few letters.

Therefore, there is a need in a distributed processing environment for a system that can use and access the user specific data in such a way as to automatically identify and extract from the user specific data appropriate graphical information that can then be transferred to a web service.

### SUMMARY

The invention is a system for identifying and extracting text in a distributed processing environment. The invention comprises a client computer coupled to a network and including a browser, a server computer coupled to the network, and information associated with a user of the client computer, where a destination service presented by the server computer to the user obtains portions of text in the information. The destination service may access the text by using a code portion that is sent to the user's computer and that is used to identify information relating to the user. Alternatively, the destination service may use a server to directly access the information specific to the user. Once the text information associated with the user is identified, the destination service may employ optical character recognition (OCR) to obtain the text information, or may request a text rendition of the internal representation of an indicated region of a graphic that includes the desired text.

### BRIEF DESCRIPTION OF THE DRAWINGS

The present invention, as defined in the claims, can be better understood with reference to the following drawings. The components within the drawings are not necessarily to scale relative to each other, emphasis instead being placed upon clearly illustrating the principles of the present invention.

FIG. 1 is a block diagram illustrating the overall system environment in which the system for automatically recognizing address information resides.

FIG. 2 is a block diagram illustrating an exemplar client computer of FIG. 1.

FIG. 3 is a block diagram illustrating an exemplar environment in which embodiments of the invention reside.

FIGS. 4A, 4B and 4C are flowcharts collectively illustrating the operation of particular embodiments of the invention.

FIG. 5 is a block diagram illustrating a preview screen presented to the user of the system for automatically recognizing address information.

### DETAILED DESCRIPTION OF THE INVENTION

The system for automatically identifying and extracting text information can be implemented in software (e.g., firmware), hardware, or a combination thereof. In one embodiment, the system for automatically identifying and extracting text information is implemented in a configuration in which a plurality of devices are coupled to a network and the user of the system uses a computer, such as a personal computer (PC) to access the connected devices, and in which the invention is implemented using primarily software. Regardless of the manner of implementation, the software portion of the invention can be executed by a special or general-purpose computer, such as a personal computer (PC: IBM-compatible, Apple-compatible, or otherwise), workstation, minicomputer, or mainframe computer.

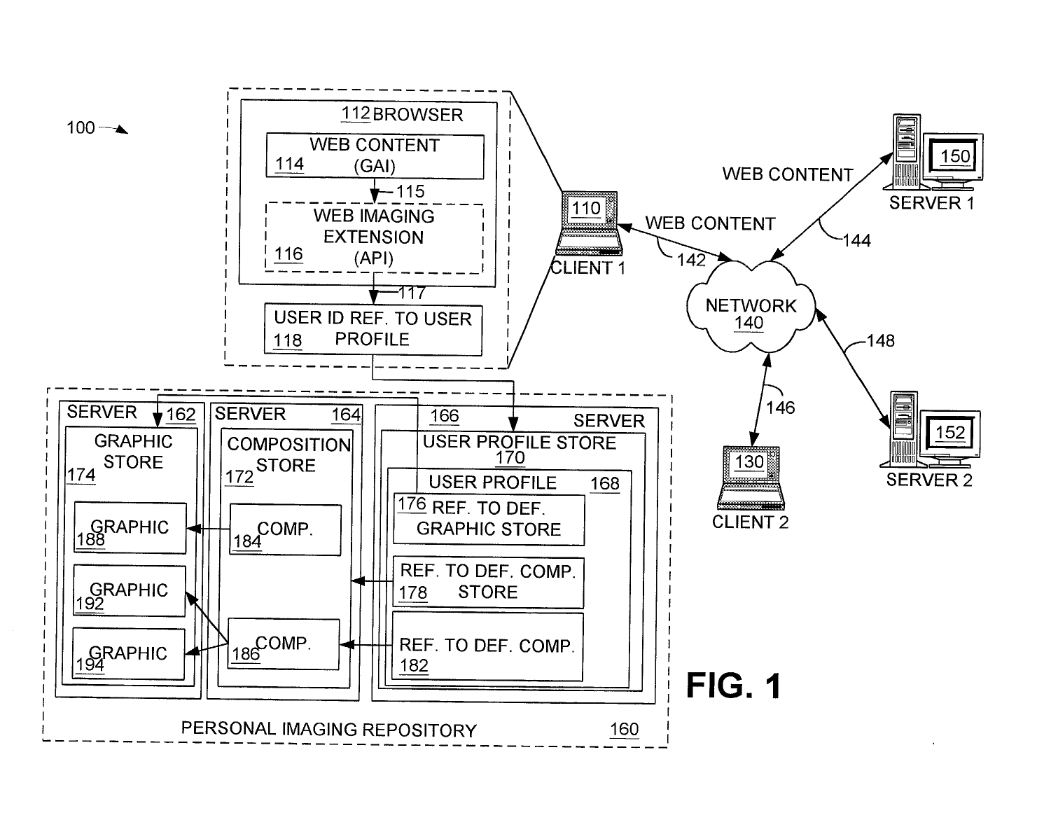

Prior to discussing particular aspects of embodiments of the invention, a brief description of the overall system and environment in which the invention resides is provided. In this regard, FIG. 1 is a block diagram illustrating the overall system environment 100 in which the system for automatically identifying and extracting text information resides. FIG. 1 illustrates a client-server environment including a first client computer 110 and a second client computer 130 coupled to a network 140. A first server 150 and a second server 152 are also coupled to the network 140. The first client computer 110 is coupled to the network 140 via connection 142 and the second client computer 130 is coupled to the network 140 via connection 146. Similarly, the first server 150 is coupled to the network 140 via connection 144 and the second server 152 is coupled to the network 140 via connection 148.

The network 140 can be any network used to couple devices and can be, for example, a LAN or a WAN. In the example to follow, the network 140 is illustratively the WWW portion of the Internet. Furthermore, the connections 142, 144, 146 and 148 can be any known connections that can couple computers to the Internet. For example, the connections 142 and 146 may be dial-up modem style connections, digital subscriber line (DSL) connections, wireless connections, or cable modem connections. The connections 144 and 148 can be high speed access lines, such as TI or other high speed communication lines.

The first client computer 110 can be, for example but not limited to, a personal computer (PC), such as a laptop computer as illustrated in FIG. 1. Similarly, the second client computer 130 can be a PC or a laptop. The first client computer 110 includes a web browser 112 (referred to hereafter as a “browser”), which receives, processes and displays web content 114. The browser 112 may also include a web imaging extension 116. Alternatively, the web imaging extension may be located elsewhere in the system 100.

The web content 114 refers to information that is received from other computers over the network 140, such as the first server 150 or the second server 152. The web imaging extension 116 is an application program interface (API) that resides on the first client computer 110, the operation of which will be described in greater detail below. The first client computer 110 also includes user identification 118. The user identification 118 is coupled to the web imaging extension 116 via connection 117 and contains a reference to a user profile 168 that is located in the user profile store 170 of the personal imaging repository (PIR) 160 to be described below. The user profile store 170 contains one or more user profiles, an exemplar one of which is illustrated using reference numeral 168. The user profile 168 contains information about the user such as a reference to the user's default graphic store 176 (to be described below). The user profile store 170 may store a number of user profiles 168 in circumstances where there are several user profiles stored within a single service.

The user profile contains information relating to the user of the system. The user profile store is a service that provides access to the user profile. The user profile store may be used to provide access to several instances of the user profile. The reference to the user profile is used to access user specific data that is included in the personal imaging repository.

Although omitted for simplicity, the second client computer 130 includes a browser, may include a web imaging extension and may include a user ID similar to the first client computer 110. Because the first client computer 110 is similar in structure and functionality to the second client computer 130, the following description will address only the first client computer 110.

The personal imaging repository 160, in this particular embodiment, includes the user specific data mentioned above. The personal imaging repository 160 can be thought of as a collection of data that can be stored on the first client computer 110 (or stored remotely from the first client computer 110) and that represents information that is specific to a particular user of the first client computer 110. The information can even be distributed among several computers and the computers among which the information is distributed can change dynamically as the personal imaging repository 160 is changed.

The personal imaging repository 160 includes a user profile store 170, a composition store 172 and a graphic store 174. Further, the user profile store 170 can be contained in a server 166, the composition store 172 can be contained in a server 164, and the graphic store 174 can be contained within a server 162. However, although shown as including three servers 162, 164, and 166, the personal imaging repository 160 may comprise a single server that can run on the first client computer 110, and that includes the user profile store 170, the composition store 172, and the graphic store 174. The user profile store 170, composition store 172, and graphic store 174 are examples of what the personal imaging repository 160 might comprise. The actual composition of the personal imaging repository 160 depends on the current configuration of the personal imaging repository 160. It is possible for the personal imaging repository 160 to contain additional composition stores and additional graphic stores. Essentially, the personal imaging repository 160 provides a layer that allows the user specific data stored within and as part of the personal imaging repository 160, to be understood by a web service to which the user of the first client computer 110 browses. Further, the information contained within the personal imaging repository 160 is dynamic, constantly changing based on the imaging information to which the user of the first client computer 110 refers.

The user profile store 170 includes a user profile 168. The user profile 168 contains information that is specific to the user of the first client computer 110, such as the reference to the default graphic store 174, the reference to the default composition store 172, and the reference to the default composition 182 associated with the user. In use, the user of the first client computer 110 browses using the browser 112 to a particular web site. For example, the web site can be located on the first server 150. The first server 150 delivers web content to the first client computer 110 which is stored as web content 114. The web content 114 invokes the web imaging extension 116, which uses the user ID 118 to make requests to the personal imaging repository 160. For example, a user ID 118 contains a reference to the user profile 168 stored on the user profile store 170. In this manner, regardless of the web site to which a user of the first client computer 110 browses, the user will see their own specific data in the context of that particular web site to which the user has browsed.

The graphic store 174 stores graphics, three of which are illustrated using reference numerals 188, 192 and 194. The graphic store 174 is essentially a network service that provides an interface for accessing and negotiating formats for graphics stored therein. A graphic, for example graphic 188, refers to the actual marks on a page that can be stored in various different formats. For example, graphics may be stored as a portable document format (.PDF), a PostScript® (a registered trademark of Adobe corporation) file, or a joint picture experts group (.JPEG) file. The graphic store 174 also determines the format in which individual graphics 188, 192 and 194 will be represented. Importantly, the graphic store 174 makes graphical data available as a network service.

In some alternative embodiments of the invention, the graphic store 174 can be a “default” graphic store. A default graphic store is one that stores graphics for unreliable web services, in addition to making graphical data available, which is done by all graphic stores.

The personal imaging repository 160 also includes composition store 172. The composition store 172 includes one or more compositions, two of which are illustrated using reference numerals 184 and 186. A composition determines the manner in which graphics are mapped into a series of pages. In FIG. 1, the composition 184 includes a reference to the graphic 188, while the composition 186, includes references to both graphics 192 and 194. The composition store 172 provides a way of negotiating the manner in which compositions will be represented.

The user profile 168 also includes a reference 176 to the default graphic store, reference 178 to the default composition store, and a reference 182 to the default composition 186. Each of the references 176, 178 and 182 can be universal resource locators (URLs) that allow the web imaging extension 116, through the user of the user ID 118 and the user profile 168, to access information (graphics and compositions) that are specific to the user of the first client computer 110.

As used herein, the term “store” as used in the user profile store 170, the composition store 172 and the graphic store 174, is used to refer to a location in a respective server 162, 164, 166 in which information is stored (i.e. a network service typically made available on a particular “port” of the server).

The web content 114 includes code portions that invoke methods that are provided in the web imaging extension 116. These methods allow the web content 114 delivered by either the first server 150 or the second server 152 to use the web imaging extension 116 to access information that is stored in the personal imaging repository 160. By using content included in the web content 114 to invoke the web imaging extension 116 to access information that is specific to the user, a user of the first client computer 110 or the second client computer 130 can have a personalized web browsing experience.

Essentially, the web content 114 is code that includes, for example, hypertext mark-up language (HTML) commands that generate images, forms, etc., and includes graphics and code such as JavaScript and Java applets. The web content 114 also includes one or more generic access instructions (GAIs) that are part of the content. The generic access instructions invoke methods provided by the web imaging extension 116 in order to access various user specific information contained in the personal imaging repository 160. In operation, code portions contained in the web content 114 make function calls to the web imaging extension 116. In accordance with an aspect of particular embodiments of the invention, by accessing user specific information, these function calls will behave differently depending upon the user specific information in the personal imaging repository. Specifically, the user ID 118 identifies and provides access to different types of information that may be different for each user. This information is maintained in the user profile 168.

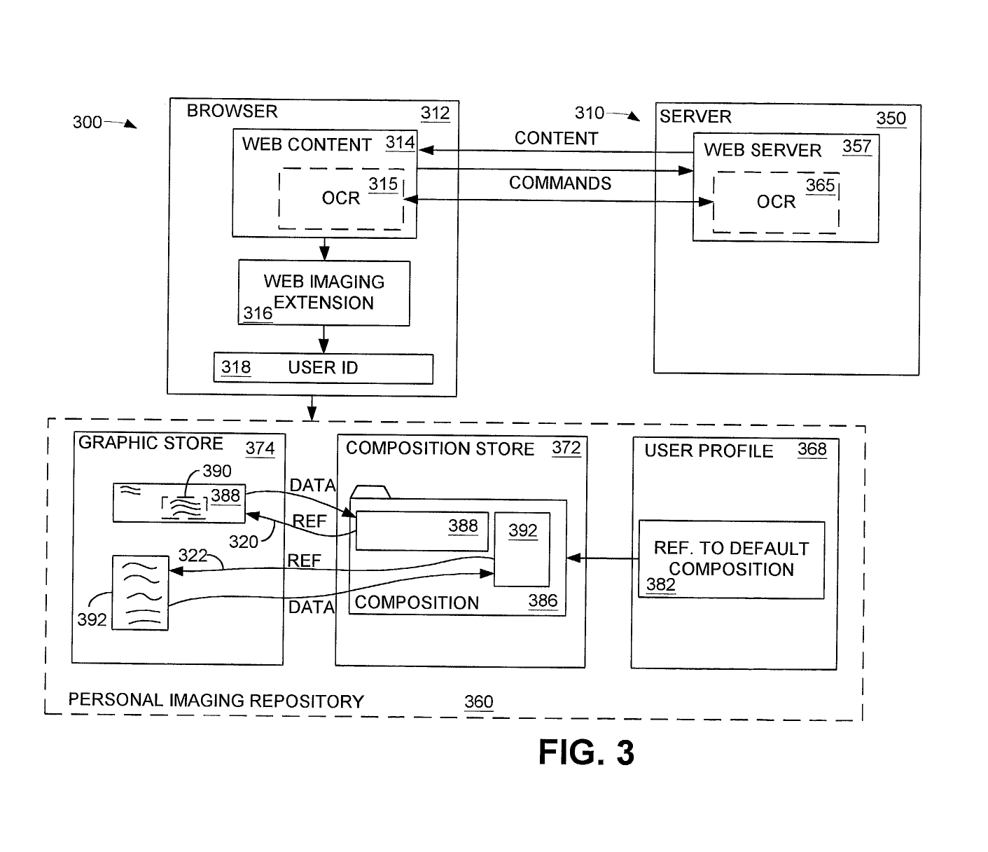

A brief description of the operation of the system shown in FIG. 1 may be helpful in understanding the operation of particular aspects of the invention to be described below with respect to FIGS. 3, 4A, 4B, 4C and 5, Assume that an individual using the client computer 110 directs the browser 112 to a particular web site located on the first server 150. Such a web site may be the user's “home service.” In such an instance, the browser 112 requests content from the web server 150, which content is delivered to the first client computer 110 and stored as web content 114. If the web content 114 includes graphical data, or the means of accessing appropriate graphical data from first server 150, the web content 114 invokes methods provided by the web imaging extension 116 to create a graphic (such as graphic 188) in the graphic store 174. As mentioned above, the web content 114 may include code that includes all the information necessary to present a web page to the user of the client computer 110 using the browser 112. Importantly, the content that is sent from the first server 150 to the first client computer 110 also includes one or more generic access instructions. The generic access instructions are a part of the web content 114 and include code that invokes methods provided by the web imaging extension 116 to access the personal imaging repository 160 and to create a graphic in the graphic store 174.

The web content 114 may then invoke another API that is provided by the web imaging extension 116 to create a new composition (such as composition 184) in the composition store 172. This new composition 184 refers to the newly created graphic 188 in the graphic store 174. The web content 114 may then invoke another API that is provided by the web imaging extension 116 to change the reference (such as reference 182 in the user profile store 170) to the default composition to refer to the newly added composition (composition 184). A default composition and a default graphic are the ones currently selected for some action and change often as the user obtains, or selects, new imaging data.

The foregoing description addresses a computing environment in which the imaging extension 116 is used to make user information available to the web content 114 downloaded into the browser 112. The imaging extension 116 makes information associated with the user's identity (i.e., the user profile 168) available. The primary purpose of the web imaging extension 116 is to provide access to information that is located in the personal imaging repository 160. In essence, this is a client-side approach to identifying user information. Alternatively, a server-side approach to identifying user information is possible. This can be accomplished by moving the logic normally present in the web content 114 running within the browser 112 into the web server 150. Rather than the web content 114 accessing the services specific to the user, the web server 150 accesses the services specific to the user. In other words, the identity technology is server-side instead of client-side.

When using server-side identity technology, and because in such an arrangement the browser 112 no longer provides information regarding the user's identity, an “authentication web site” can be used to provide such information. In such an arrangement, the web imaging home page, or more generally, any imaging destination, or destination service, redirects the browser 112 to the authentication web site. The authentication web site determines the identity of the user and then redirects the browser 112 back to the web imaging home page with the user's identity, including the location of the user's profile. In this scheme, it is assumed that all imaging destinations have information regarding the authentication server. Once the user's identity is determined (i.e., the location of the user's profile is known) the web imaging home page can directly interact with services specific to the user without the aid of the imaging extension.

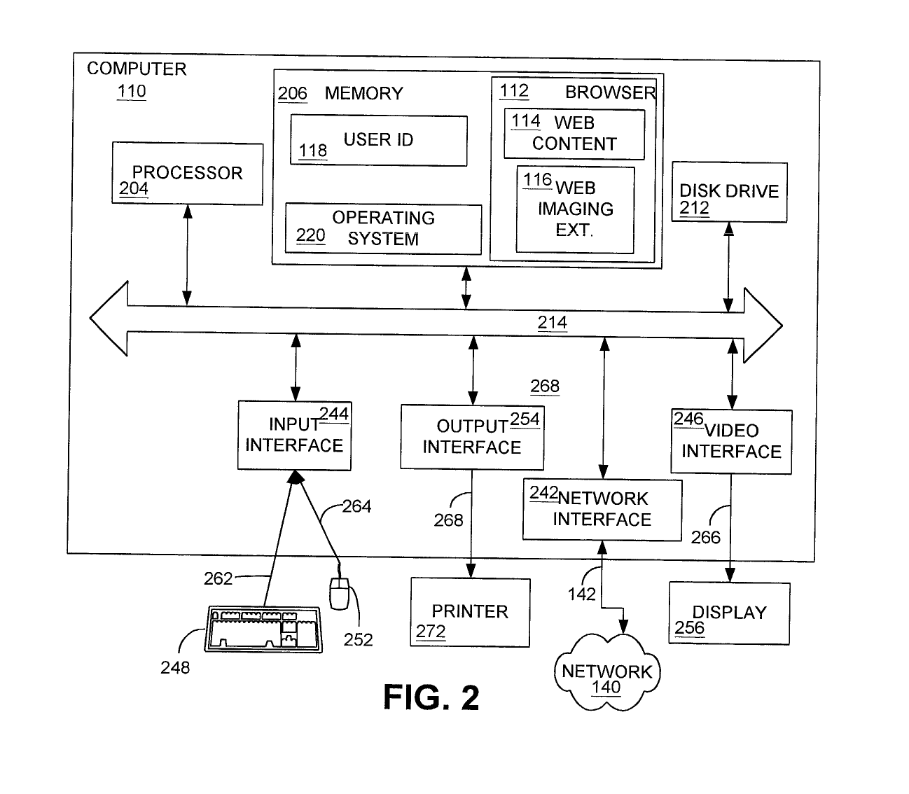

An example of a general-purpose computer that can implement the software of the invention is shown in FIG. 2.

FIG. 2 is a block diagram illustrating an exemplar first client computer 110 of FIG. 1. The first client computer 110 can implement the system for identifying and extracting text in a web based imaging environment. The web content 114, web imaging extension 116 and the user ID 118 and other software and hardware elements (to be discussed with respect to FIG. 2) work in unison to implement the functionality of the invention. Generally, in terms of hardware architecture, as shown in FIG. 2, the first client computer 110 includes a processor 204, memory 206, a disk drive 212, an input interface 244, a video interface 246, an output interface 254 and a network interface 242 that are connected together and can communicate with each other via a local interface 214. The local interface 214 can be, for example but not limited to, one or more buses or other wired or wireless connections, as is known to those having ordinary skill in the art. The local interface 214 may have additional elements, which are omitted for simplicity, such as buffers (caches), drivers, and controllers, to enable communications. Further, the local interface 214 includes address, control, and data connections to enable appropriate communications among the aforementioned components.

The processor 204 is a hardware device for executing software that can be stored in memory 206. The processor 204 can be any custom made or commercially available processor, a central processing unit (CPU) or an auxiliary processor among several processors associated with the computer 110, and a microchip-based microprocessor or a macroprocessor. Examples of suitable commercially available microprocessors are as follows: a PA-RISC series microprocessor from Hewlett-Packard Company, an 8086 or Pentium series microprocessor from Intel Corporation, a PowerPC microprocessor from IBM Corporation, a Sparc microprocessor from Sun Microsystems, Inc., or a 68xxx series microprocessor from Motorola Corporation.

The memory 206 can include any one or combination of volatile memory elements (e.g., random access memory (RAM, such as DRAM, SRAM, etc.)) and nonvolatile memory elements (e.g., RAM, ROM, hard drive, tape, CDROM, etc.). Moreover, the memory 206 may incorporate electronic, magnetic, optical, and/or other types of storage media. Note that the memory 206 can have a distributed architecture, where various components are situated remote from one another, but can be accessed by the processor 204.

The input interface 244 can receive commands from, for example, keyboard 248 via connection 262 and from mouse 252 via connection 264 and transfer those commands over the local interface 214 to the processor 204 and the memory 206.

The video interface 246 supplies a video output signal via connection 266 to the display 256. The display 256 can be a conventional CRT based display device, or can be any other display device, such as a liquid crystal display (LCD) or other type of display. The output interface 254 sends printer commands via connection 268 to the printer 272.

The network interface 242, which can be, for example, a network interface card located in the first client computer 110 or a modulator/demodulator (modem), can be any communication device capable of connecting the first client computer 110 to an external network 140.

The software in memory 206 may include one or more separate programs, each of which comprises an ordered listing of executable instructions for implementing logical functions. In the example of FIG. 2, the software in the memory 206 includes the software required to run the browser 112 and process the web content 114. The memory 206 also includes the web imaging extension 116 and stores the user ID 118. The memory 206 also includes a suitable operating system (O/S) 220. With respect to the operating system 220, a non-exhaustive list of examples of suitable commercially available operating systems 220 is as follows: a Windows operating system from Microsoft Corporation, a Netware operating system available from Novell, Inc., or a UNIX operating system, which is available for purchase from many vendors, such as Hewlett-Packard Company, Sun Microsystems, Inc., and AT&T Corporation. The operating system 220 essentially controls the execution of other computer programs, such as the browser 112, and provides scheduling, input-output control, file and data management, memory management, and communication control and related services. The processor 204 and operating system 220 define a computer platform, for which application programs, such as the browser 112, are written.

If the first client computer 110 is a PC, the software in the memory 206 further includes a basic input output system (BIOS) (omitted for simplicity). The BIOS is a set of essential software routines that test hardware at startup, start the O/S 220, and support the transfer of data among the hardware devices. The BIOS is stored in ROM so that it can be executed when the first client computer 110 is activated.

When the first client computer 110 is in operation, the processor 204 is configured to execute software stored within the memory 206, to communicate data to and from the memory 206 and to generally control operations of the first client computer 110 pursuant to the software. The browser 112, portions of the web content 114, web imaging extension 116 and the O/S 220, in whole or in part, but typically the latter, are read by the processor 204, perhaps buffered within the processor 204, and then executed.

When the system for automatically identifying and extracting text information is implemented primarily in software, as is shown in FIG. 2, it should be noted that the browser 112, web content 114 and web imaging extension 116 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The browser 112, web content 114 and web imaging extension 116 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The hardware components of the invention can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

FIG. 3 is a block diagram 300 illustrating an exemplar environment in which the system for automatically identifying and extracting text information resides. The system 300 includes a browser 312 including web content 314 and a web imaging extension 316. The client computer (i.e., client computer 110 of FIGS. 1 and 2) on which the browser 312 executes is omitted for simplicity. The browser 312 is coupled to a web site 310. The web site 310 includes a server computer 350, which includes a web server 357. The web server 357 includes web pages, an exemplar one of which is illustrated using reference numeral 365, and containing optical character recognition (OCR) logic. For ease of illustration, but not limited to the following example, the web site 310 can be a web site at which a user of the browser 312 wishes to purchase a service. For example, the web site 310 can be a web site that sells, for example, postage. Further, the browser 312 is coupled to the server computer 350 typically via a network, such as the Internet.

When a user of the browser 312 browses to the web site 310, commands and information are sent from the browser 312 to the server 350. Typically, in response to the commands sent by the browser 312, the server computer 350, and more particularly, the web server 357, creates content and serves the content to the browser 312, where it is stored as web content 314.

In some instances, and as described above with respect to FIG. 1, the content 314 may make use of web imaging extension 316 resident on the browser 312. The web imaging extension 316 is an API that provides access to the user's personal imaging repository 360 when client-side identity is used. The personal imaging repository 360 is similar to the personal imaging repository 160 described above in FIG. 1. The personal imaging repository 360 can be thought of as a place that information specific to the user of the browser 312 is stored.

In the example shown in FIG. 3, the one or more server machines that comprise the personal imaging repository 360 have been omitted for simplicity. The personal imaging repository 360 includes a composition store 372 and a graphic store 374, which are similar to the composition store 172 and the graphic store 174 described above in FIG. 1. However, in this example, and because the web site 310 is shown for illustrative purposes as a web site from which the user of the browser 312 can buy postage, the graphic store 374 includes an envelope shaped graphic 388 and a letter shaped graphic 392. The composition store 372 includes a composition 386, which may include the envelope graphic 388 and the letter graphic 392.

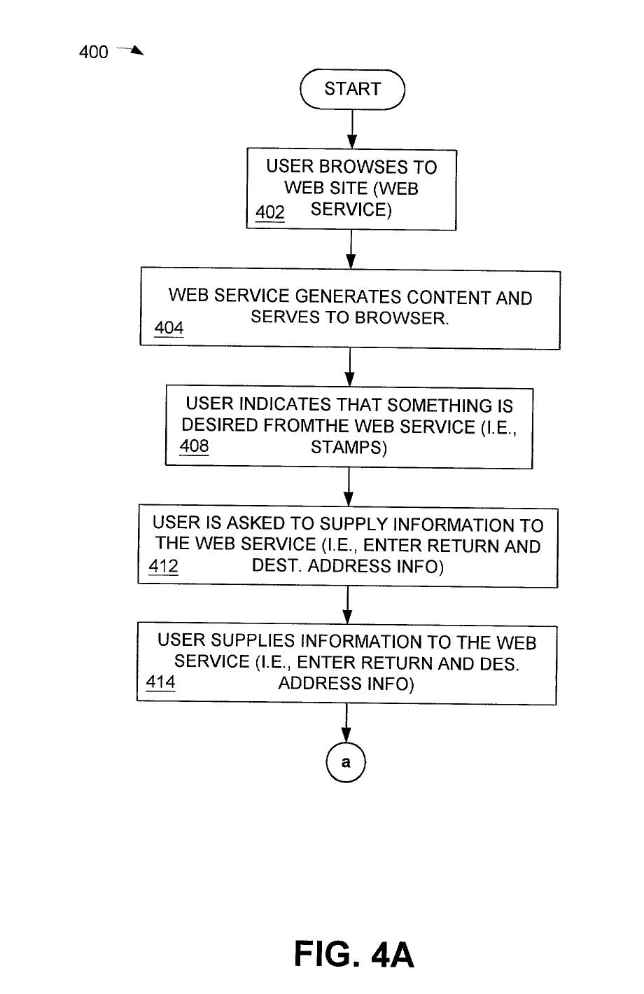

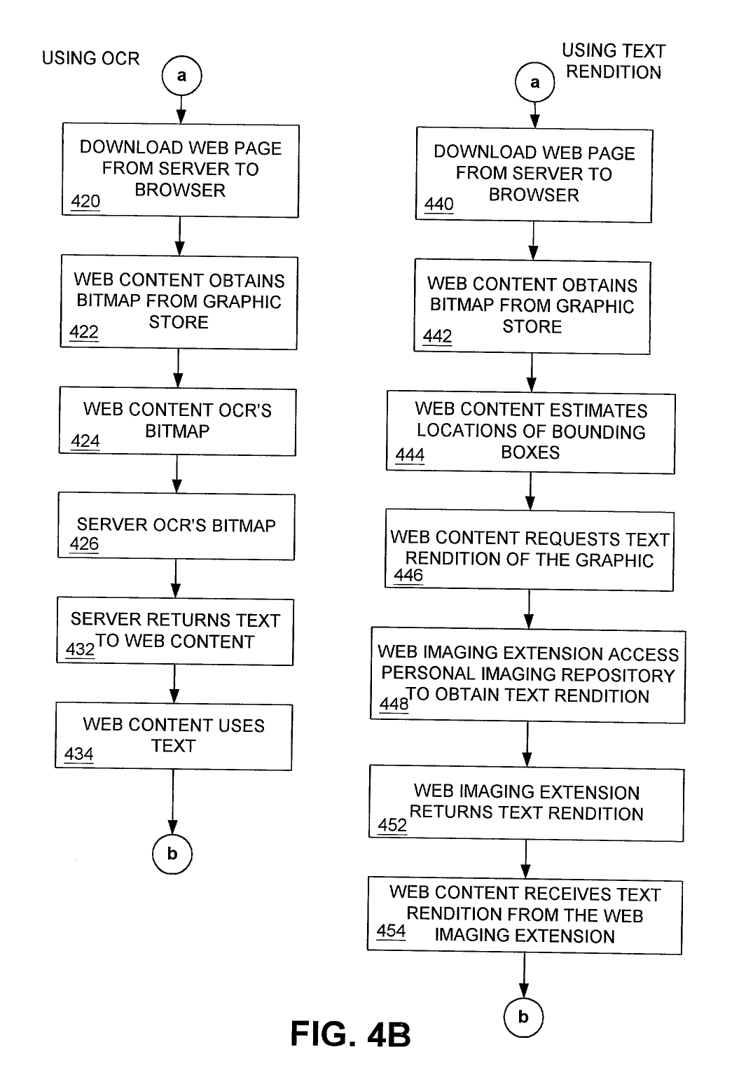

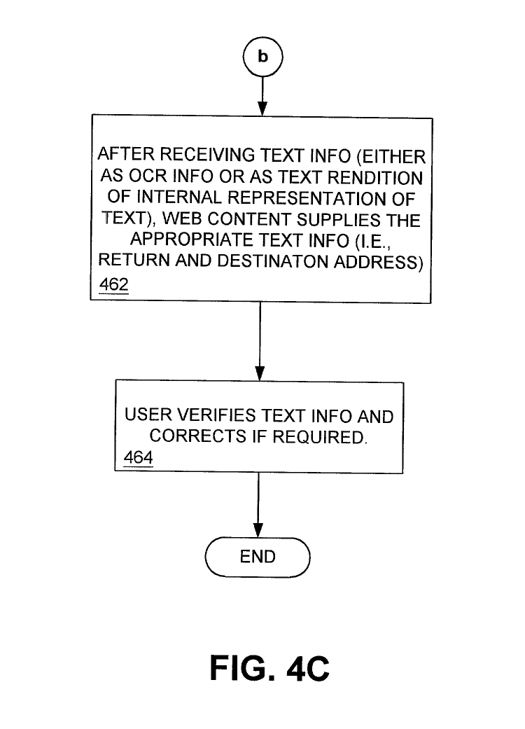

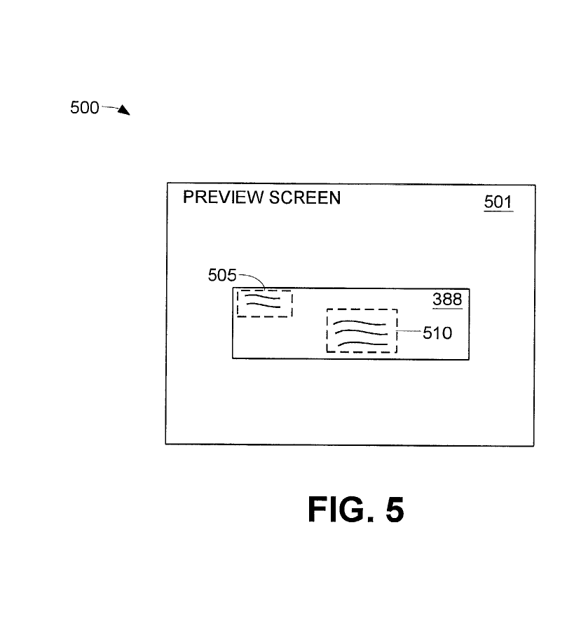

In accordance with an aspect of the invention, and to be described more fully below with respect to FIGS. 4A, 4B, 4C and FIG. 5, the web content 314 invokes the web imaging extension 316 in order to access the composition store 372. The composition 386 includes references 320 and 322 to the envelope graphic 388 and the letter graphic 392, respectively. In this manner, when the user of the browser 312 browses to the web site 310 and receives web content 314 relating to the purchase of postage, the web imaging extension 316 receives as part of the web content 314, an instruction to access the personal imaging repository 360. In this manner, information provided to the user of the browser 312 via the web content 314 allows the graphical information contained in the graphic store 374 to be used to present to the user of the browser 312 a personalized web browsing experience. For example, when the user uses the browser 312 to access the web site 310 and indicates that postage is desired, the user of the browser 312 will see on their screen one or more images that represent the envelope graphic 388 and the letter graphic 392.

FIGS. 4A, 4B and 4C are flowcharts collectively illustrating the operation of particular embodiments of the invention. The flow charts of FIGS. 4A, 4B and 4C show the architecture, functionality, and operation of a possible implementation of the system for automatically identifying and extracting text information. In this regard, each block represents a module, segment, or portion of code, which comprises one or more executable instructions for implementing the specified logical function(s). It should also be noted that in some alternative implementations, the functions noted in the blocks may occur out of the order noted in FIGS. 4A, 4B and 4C. For example, two blocks shown in succession in FIG. 4A may in fact be executed substantially concurrently or the blocks may sometimes be executed in the reverse order, depending upon the functionality involved, as will be further clarified below.

With reference to FIG. 4A, in block 402 a user of the browser 312 browses to a web site 310, also referred to as a destination service. In block 404, the web server 357 located at the destination service generates content and serves the content to the browser 312. The browser stores the content as web content 314. In this example, the content makes use of the web imaging extension 316. In block 408, a user of the browser 312 indicates that something is desired from the web site 310. For example, the user of the browser 312 may indicate that they desire to buy postage from the web site 310. In block 412, the user is requested by the web site 310 to supply information to the web site 310. For example, in the example of buying postage, the user is requested to enter the return and destination address information and supply this information to the web site 310. Typically, the browser 312 will present to the user a screen (received from the web server 357 as part of the web content 314) that includes one or more blank spaces into which the user is asked to type the required information. In the case of buying postage as described herein, the user of the browser 312 will be shown a screen that asks the user to enter return address and destination address information. As will be described below, the invention allows the user to automatically supply this information based on user specific information included in the user's personal imaging repository 360.

In block 414, the user supplies this information to the web server 357. This is accomplished by the web content 314 invoking the web imaging extension 316 to sort through all available pages in the composition 386 until it identifies one that is the format and size of an envelope. Such an envelope format graphic is represented in the personal imaging repository 360 using envelope graphic 388, as described above in the general description of the system with respect to FIG. 1.

With reference now to FIG. 4B, blocks 420, 422, 424, 426, 432 and 434 illustrate one embodiment of the invention in which optical character recognition (OCR) is used to extract textual information from the graphic store 374.

In blocks 440, 442, 444, 446, 448, 452 and 454, an alternative embodiment of the invention will be described that provides a text rendition of the internal representation of an indicated region of a graphic as the method by which textual information is extracted from the graphic store 374.

Using OCR:

In block 420, the web page 365 containing OCR related logic is downloaded into browser 312 (effectively being stored within the browser as web content 314). When downloaded into web browser 312, web content containing OCR related logic 365 essentially becomes OCR web content 315

In block 422, the web content 315 containing OCR related logic running within the browser 312 obtains a bitmap (compressed or not, lossy or lossless) from the graphic store 374. To obtain the bitmap, the web content 315 calls methods on the web imaging extension 316. The web imaging extension 316 invokes the appropriate methods on the composition store 372 and the graphic store 374 such that a bitmap form of the envelope graphic 388 is returned. In this example, the bitmap is of the envelope graphic 388 and is of sufficient quality to enable the web imaging extension 316 to perform OCR.

In block 424, the web content 314 performs OCR on the bitmap of the envelope graphic 388. Optionally, in block 426, the web content 314 performs OCR by transmitting the bitmap back to the web server 357 (or to another service located on the same machine as the web server). The web server 357 then performs OCR on the bitmap of the envelope graphic 388 on behalf of the web content 314.

In block 432, the web server 357 returns text corresponding to the OCR'd bitmap of the envelope graphic 388 back to web content 314 (assuming that the optional block 426 was performed). The text is representative of the textual information present on the envelope graphic 388.

In block 434, having performed OCR on the bitmap of the envelope graphic 388 (either directly or by delegation to the web server 357), the web content 314 uses the text data obtained from the personal imaging repository to, for example, complete the form presented by the web server 350 in block 418.

It should be noted that part of the OCR process may include identifying a bounding box around the appropriate parts of the bitmap. For a bitmap representing an envelope, this would be the upper left hand corner and the middle portion. Algorithms already exist to bound a region of text. These algorithms identify a region of high frequency data.

Using Internal Representation:

As used in this document, internal representation refers to a text rendition of an internal representation of a text region of the graphic contained within the graphic store 374, to enable the web content 314 to draw an image for presentation to the user of the browser 312. The image is as shown in FIG. 5. However, in this embodiment, the web imaging extension 316 is implemented as a set of API's, which can be invoked by the web content 314 to extract a text rendition of the internal representation of the text information located on the envelope graphic 388 from the graphic store 374.

An internal representation refers to the format in which information (in this example, text) is intermediately stored within an application (in this example, the graphic store 374). In accordance with this aspect of the invention, the graphic store 374 can implement an interface that directly makes available a text rendition of the internal representation of the text information contained in the envelope graphic 388.

Every application stores information in its own “internal representation,” which only that application can directly use. When that information is saved, the application converts its “internal representation” into some file format. In some cases (but not all), the file format can later be used to replicate the exact (or an equivalent) “internal representation” used to generate the file. In any case, the application could supply other interfaces to the “internal representation” (beyond just saving a file to disk). The graphic store can provide an interface for accessing the “internal representation” of an application in a controlled manner. The application could implement the “graphic store” interface and in response to a request through this interface access the “internal representation.” Depending on the particular “internal representation” it is possible to obtain the text associated with a particular region.

In block 440, the web content 314 is downloaded to the browser 312. In block 442, the web content 314 obtains a bitmap of the envelope graphic 388 from the graphic store 374 and determines appropriate bounding boxes of text regions (such as the regions of the envelope graphic 388 that include return and destination address text). Alternatively, in block 444, the web content 314 estimates the location of bounding boxes of text regions based on reasonable assumptions regarding the layout of an envelope.

In block 446, the web content 314 requests a text version of a region of the envelope graphic 388 (such as the address portion of the envelope graphic) by calling appropriate methods provided by the web imaging extension 316.

It should be noted that the process of obtaining text that is to be described below is similar to the process that was used to obtain the bitmap graphic described above. The web content 314 calls methods on the web imaging extension 316, which invokes the appropriate methods of the composition store 372 and the graphic store 374 such that a bitmap form of the envelope graphic 388 is returned to the web content 314.

In block 448, in response to being called by the web content 314, the web imaging extension 316 accesses the user's personal imaging repository 360 and obtains a text rendition of the region of the envelope graphic 388 that was requested. Specifically, the web content 314 uses the user ID 318 (similar to 118 of FIG. 1) to find the user profile 368 (similar to 168 of FIG. 1), and uses the user profile 368 to find the default composition (composition 386 in this example). The web content 314 uses the default composition 386, to find the envelope sized page (388) of the composition and uses the envelope sized page 388 of the composition to obtain the graphic (i.e., graphic 390 located on the envelope graphic 388) corresponding to the desired region. The web content 314 obtains from the graphic a text rendition of the region 390 corresponding to that graphic. It is possible (although unlikely) that the region in question will span multiple graphics. If such is the case, then several graphics will be interrogated for the text rendition.

In block 452, the web imaging extension 316 returns the text rendition of the graphic 390 to the web content 314. In block 454, the web content 314 receives the text rendition 390 of the block in question from the web imaging extension and completes the appropriate fields in the image that was presented to the user in block 412.

It should be mentioned that OCR may be used by the graphic store 374 (or possibly the composition store 386) to obtain the textual representation of the specified region of the graphic. In any case, the use of OCR is opaque to the web content 314 and the web imaging extension 316.

Referring now to FIG. 5, shown is a graphical illustration 500 illustrating the preview screen 501 presented to the user of the browser 212. The preview screen 501 includes the envelope graphic 388 on which bounding boxes 505 and 510 have been applied at locations likely to contain textual information. The bounding box 505 is applied around what appears to be return address information and the bounding box 510 is applied around what appears to be the destination address information. In this manner, the areas of the envelope graphic 388 that are likely to and appear to include relevant textual information have bounding boxes applied thereto, and such information is used by the web content 314 to extract the textual information from the envelope graphic 388.

FIG. 4C is the balance of the flow chart describing the final steps that occur after the text information is supplied to the web content 314 from the personal imaging repository 360. In block 462, after receiving the text information, the web content 314 supplies the appropriate text information to the browser 312. Specifically, the web content 314 fills in the appropriate text information (i.e., the return and destination address) into the spaces that are provided on the document that is being viewed by the user of the browser 312. In this example, the return address information and the destination information are automatically applied into the appropriate places and then presented to the user of the browser 312. In block 464, the user verifies and, if required, corrects the text information.

It will be apparent to those skilled in the art that many modifications and variations may be made to the preferred embodiments of the present invention, as set forth above, without departing substantially from the principles of the present invention. For example, the invention can be used to extract any textual information from a graphic located in the personal imaging repository. All such modifications and variations are intended to be included herein within the scope of the present invention, as defined in the claims that follow.

What is claimed is:

1. A system for identifying and extracting text in a distributed processing environment, comprising:
a client computer coupled to a network and including a browser;
a server computer coupled to the network; and
information associated with a user of the client computer, where a destination service presented by the server computer to the user obtains portions of text in the information.

2. The system of claim 1, wherein the text is extracted from the information using optical character recognition.

3. The system of claim 1, wherein the text is represented by a text rendition of an internal representation of an indicated region of the text.

4. The system of claim 1, wherein the information associated with the user of the client computer is graphical information that includes textual information.

5. The system of claim 4, wherein the graphical information is identified using a uniform resource locator (URL).

6. The system of claim 1, wherein the information is specific to a user of the first client computer.

7. The system of claim 1, wherein the information resides on the first client computer.

8. The system of claim 1, wherein the information resides remote from the first client computer.

9. The system of claim 1, wherein the destination service uses a code portion in the browser to obtain the portions of text in the information.

10. The system of claim 1, wherein the destination service uses the server to directly access and obtain the portions of text in the information.

11. The system of claim 1, wherein the portions of text in the information are used to complete a web page form.

12. A method for identifying and extracting text in a distributed processing environment, the method comprising:
coupling a client computer to a network, the client computer including a browser;
coupling a server to the network;
associating information with a user of the client computer; and
obtaining portions of text in the information using a destination service presented by the server computer to the user.

13. The method of claim 12, wherein the text is extracted from the information using optical character recognition.

14. The method of claim 12, further comprising:
representing the text as a text rendition of an internal representation of an indicated region of the text; and
directly extracting the text rendition.

15. The method of claim 12, wherein the information associated with the user is graphical information that includes textual information.

16. The method of claim 15, further comprising identifying the graphical information using a uniform resource locator (URL).

17. The method of claim 12, wherein the information is specific to a user of the first client computer.

18. The method of claim 12, wherein the information resides on the first client computer.

19. The method of claim 12, wherein the information resides remote from the first client computer.

20. The method of claim 12, wherein the portions of text in the information are obtained using a code portion in the browser.

21. The method of claim 12, wherein the server directly accesses and obtains the portions of text in the information.

22. The method of claim 12, further comprising using the portions of text in the information to complete a web page form.

23. A computer readable medium having a program for identifying and extracting text in a distributed processing environment, the program comprising logic for:
coupling a client computer to a network, the client computer including a browser;
coupling a server to the network;
associating information with a user of the client computer; and
obtaining portions of text in the information using a destination service presented by the server computer to the user.

24. The program of claim 23, wherein the text is extracted from the information using optical character recognition.

25. The program of claim 23, further comprising:
logic for representing the text as a text rendition of an internal representation of an indicated region of the text; and
logic for directly extracting the text rendition.

26. The program of claim 23, wherein the information associated with the user is graphical information that includes textual information.

27. The program of claim 26, further comprising logic for identifying the graphical information using a uniform resource locator (URL).

28. The program of claim 23, wherein the information is specific to a user of the first client computer.

29. The program of claim 23, wherein the information resides on the first client computer.

30. The program of claim 23, wherein the information resides remote from first client computer.

31. The program of claim 23, wherein the portions of text in the information are obtained using a code portion in the browser.

32. The program of claim 23, wherein the server directly accesses and obtains the portions of text in the information.

33. The program of claim 23, further comprising logic for using the portions of text in the information to complete a web page form.
